(19) United States
(12) Patent Application Publication
(10) Pub. No.: US 2008/0303631 A1
(43) Pub. Date: Dec. 11, 2008

(54) Mass Storage Device With Locking Mechanism

(76) Inventors: John S. Beekley, Danville, CA (US); Donald A. Lieberman, San Jose, CA (US); Ngon V. Le, Fremont, CA (US)

Correspondence Address: MORGAN, LEWIS & BOCKIUS, LLP., 2 PALO ALTO SQUARE, 3000 EL CAMINO REAL, PALO ALTO, CA, 94306, US

(21) Appl. No.: 11/758,634

(22) Filed: Jun. 5, 2007

(51) Int. Cl. G05B 19/00

(52) U.S. Cl. 340/5.74

(57) ABSTRACT

Embodiments of a mass storage device having a locking mechanism are described. The mass storage device includes a wireless reader to receive identification data from a wireless transponder, and to determine if the identification data matches a pre-stored data. The mass storage device includes a first controller device to enable access to at least a portion of a mass storage unit when the wireless reader determines that the identification data matches the pre-stored data. In one embodiment, a method of locking a mass storage device is described. The method includes receiving first identification data from a first wireless transponder at a mass storage device and unlocking the mass storage device upon determining that the first identification data matches a first pre-stored data.

### TECHNICAL FIELD

The disclosed embodiments relate generally to a mass storage device with a locking system, and more particularly to a portable mass storage device with a wireless locking system.

### BACKGROUND

Portable mass storage devices have the advantages of having large memory capacity and small volume to enable easy carrying, and therefore have become popular storage mediums for use with computer systems.

An example of a portable mass storage device is a USB drive. A USB drive typically includes a storage unit, such as a flash memory chip, to store data. The USB drive also includes a USB mass storage controller to control access to the storage unit. The USB drive also includes a USB connector that provides an interface to a host computer. The USB connector can be a male type-A connector that connects the USB drive directly to a port on the host computer.

Data stored on a portable mass storage device, such as, on the storage unit of the USB drive, is vulnerable to unauthorized access.

### BRIEF DESCRIPTION OF THE DRAWINGS

FIG. 1 is a block diagram illustrating a mass storage device with a locking mechanism according to an embodiment of the invention.

FIG. 2 is a block diagram illustrating a mass storage device with a locking mechanism according to an embodiment of the invention.

FIG. 3 is a block diagram illustrating a USB mass storage device with a locking mechanism according to an embodiment of the invention.

FIG. 4 is a flow diagram of a process for unlocking a mass storage device with a locking mechanism according to an embodiment of the invention.

FIG. 5 is a flow diagram of a process for unlocking a mass storage device with a locking mechanism according to an embodiment of the invention.

FIG. 6 is a flow diagram of a challenge and response process for unlocking a mass storage device with a locking mechanism according to an embodiment of the invention.

FIG. 7 is a block diagram illustrating an identification number stored and transmitted by a wireless transponder according to an embodiment of the invention.

### DESCRIPTION OF EMBODIMENTS

In one embodiment, methods and systems to lock and unlock a mass storage device, thus preventing unauthorized access to the USB drive, are described.

Embodiments of a mass storage device having a locking mechanism are described. The mass storage device includes a wireless reader to receive identification data from a wireless transponder, and to determine if the identification data matches a pre-stored data. The mass storage device includes a first controller device to enable access to at least a portion of a mass storage unit when the wireless reader determines that the identification data matches the pre-stored data.

In one embodiment, a method of locking a mass storage device is described. The method includes receiving first identification data from a first wireless transponder at a mass storage device and unlocking the mass storage device upon determining that the first identification data matches a first pre-stored data.

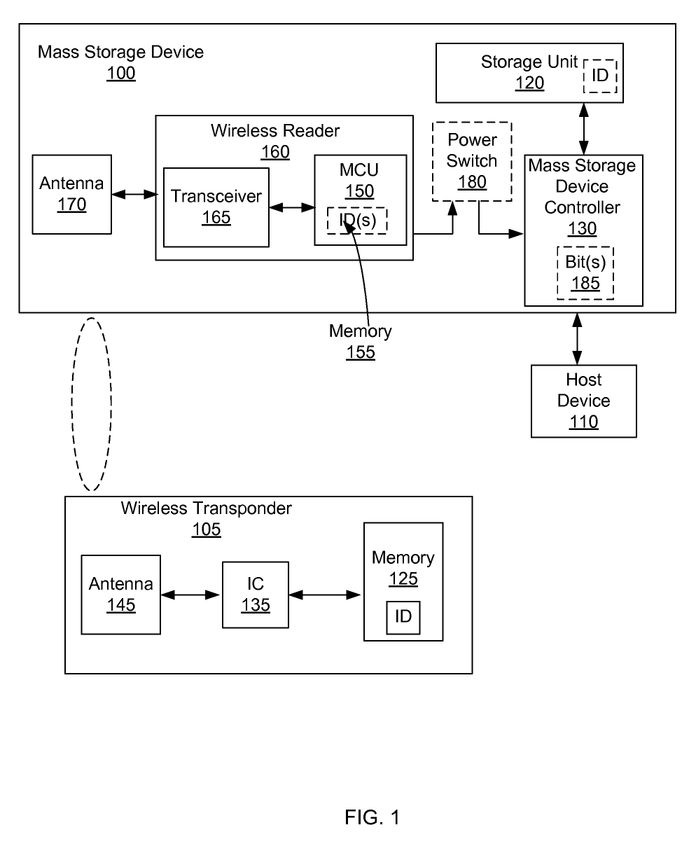

FIG. 1 illustrates a portable mass storage device 100 with a locking mechanism and a wireless transponder 105 according to an embodiment of the invention. Mass storage device 100 includes a mass storage device controller 130, one or more storage unit(s) 120, a wireless reader 160 and an antenna 170. Mass storage device 100 may interface with a host device 110, such as a computer, using one or more interfaces, e.g., including a connector (not shown).

Mass storage device controller 130 operates to manage a flow of data between host device 110 and storage unit 120. Mass storage device controller 130 may contain a small microprocessor and a small amount of on-chip ROM and RAM (not shown). Mass storage device 100 communicates with a wireless transponder device 105 using a wireless reader 160 and antenna 170. Although antenna 170 is shown to be separate from wireless reader 160, in one embodiment, it may be a part of wireless reader 160.

According to some embodiments of the invention, in order to gain access to data stored on mass storage device 100, a user brings wireless transponder device 105 in a proximal range of mass storage device 100. A function of wireless transponder device 105 is to receive an excitation signal from wireless reader 160 and modify the excitation signal in some ways indicative of data identifying the particular wireless transponder that did the modification. Wireless transponder device 105 then transmits the modified signal back to wireless reader 160. In one embodiment, in the absence of stimulus from reader 160, wireless transponder device 105 is dormant and does not transmit data of its own volition.

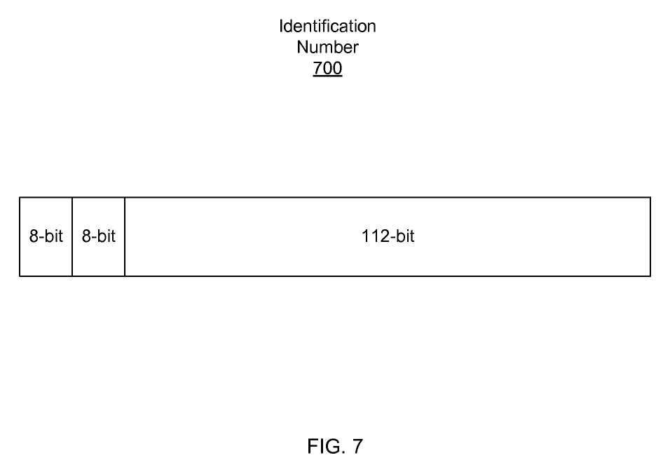

Wireless transponder device 105 includes a transponder circuit 135, a transmitter/receiver antenna 145 and a memory 125. When brought in proximity to mass storage device 100 containing wireless reader 160, transponder circuit 135 is excited. Transponder circuit 135 is powered by power derived from rectification of incoming wireless signals received from wireless reader 160 or can be self powered. Transponder circuit 135 also includes digital control circuitry to control switching of the antenna connection, whether wireless transponder device 105 is sending or receiving, and reading memory 125. Wireless transponder device 105 also has on-board nonvolatile memory 125 for storing data such as a unique serial number identifying the particular wireless transponder device 105. In one embodiment, at manufacturing time, wireless transponder device 105 is programmed with a unique serial number, referred to herein, as an “Identification Number”. Identification Numbers are discussed in greater detail with reference to FIG. 7. Wireless transponder device 105 may also contain MCU that functions like a crypto processor to process encrypted data.

In one embodiment, digital control circuitry 135 keeps wireless transponder device 105 locked so that wireless transponder device 105 cannot alter data in memory 125. Digital control circuitry 135 can also keep wireless transponder device 105 locked so that wireless transponder device 105 cannot or read and transmit data from memory 125 until digital control circuitry 135 detects reception of an unlock sequence. Wireless reader 160 unit knows the unlock sequence for unlocking wireless transponder device 105 to for interrogation, and transmits that sequence plus interrogation or other commands to wireless transponder device 105.

In one embodiment, wireless transponder device 105 is a passive tag. In one embodiment, memory 125 of wireless transponder device 105 is fixed and unalterable, such as ROM or even hardwired connections, thus rendering wireless transponder device 105 read-only.

In another embodiment, for higher security, memory 125 is read-writable. For instance, memory 125 is a 128-bit Programmable Read-Only Memory (“PROM”), thus rendering wireless transponder device 105 read-writeable. Accordingly, a passive read-writable tag allows data stored on and emitted by wireless transponder device 105 to be modified or rewritten during uses, thus further enhancing security. In this case, wireless transponder device 105 is read-writeable. In yet another embodiment, for additional security, wireless transponder device 105 contains a crypto processor to handle data/key encryption and decryption.

Wireless reader 160 includes a microcontroller unit (MCU) 150 for controlling reader functionality and programming. A transceiver circuit 165 is associated with MCU 150. Transceiver circuit 165 generates wireless signals to be passed to antenna 170 for communication with wireless transponder device 105. In one embodiment, an error-detection algorithm, such as the CRC (Cyclic Redundancy Check) algorithm, is implemented at MCU 150 to detect error in transmission. Wireless reader 160 receives the Identification Number from wireless transponder device 105. MCU 150 compares the received Identification Number to pre-stored identification data stored in memory 155 and determines if there is a match.

In some embodiments, wireless reader 160 stores Identification Numbers for one or more matching wireless transponder devices 105 in memory 155 of MCU 150. Wireless reader 160 stores Identification Numbers that correspond to pre-stored Identification data stored in MCU 150. In some embodiments, wireless reader 160 stores Identification Numbers that match pre-stored Identification data stored in MCU 150. In one embodiment, wireless reader 160 stores multiple unique Identification Numbers. In this manner, multiple users, each having one or more associated wireless transponder devices 105, can access one or more same or different portions of storage unit 120. Alternatively, or in addition, the pre-stored identification data can be stored in storage unit 120 and or in mass storage device controller 130.

In one embodiment, memory 155 is non-volatile. In one embodiment, memory 155 is EEPROM. Accordingly, once the one or more Identification Numbers have been successfully programmed, EEPROM 155 fuse is burnt. EEPROM 155 thus acts as read-only device to prevent data tampering. EEPROM 155 may include 1 KB in-system programmable Flash.

If there is a match between one or more Identification Numbers stored at MCU 150 and the Identification Number(s) received from wireless transponder device 105, MCU 150 provides mass storage device controller 130 with this information, so that mass storage device controller 130 can enable access to storage unit 120 by host device 110. In one embodiment, mass storage device controller 130 periodically polls MCU 150 for match information.

In one embodiment, MCU 150 provides mass storage device controller 130 with match information by setting one or more bits 185. Accordingly, a single flag bit or multiple bits 185 stored in mass storage device controller 130 can be used to indicate a match between a received Identification Number and pre-stored identification data. By default, flag bit(s) 185 in mass storage device controller 130 can be set to indicate that there is no match. Once wireless transponder device 105 and wireless reader 160 have communicated successfully, MCU 150 clears bit(s) 185 in mass storage device controller 130. In one embodiment, the bit(s) 185 are used to turn on the mass storage device controller 130.

In another embodiment, MCU 150 provides mass storage device controller 130 with match information by powering on a power switch 180. When powered on, power switch 180 powers up mass storage device controller 130. Mass storage device controller 130 then enables access to storage unit 120 by host device 110.

In one embodiment, mass storage device controller 130 enables access to entire storage unit 120 by host device 110. In one embodiment, mass storage device controller 130 enables access to only a portion of storage unit 120 by host device 110. In certain other embodiments, mass storage device controller 130 enables access to most portions of storage unit 120.

In one embodiment, storage unit 120 (or the part that is unlocked) remains unlocked as long as mass storage device 100 is connected to an active host device 110. Once mass storage device 100 is disconnected from active host device 110, storage unit 120 (or the part that is unlocked) becomes locked. In one embodiment, mass storage device controller 130 employs additional mechanisms to protect storage unit 120 from unauthorized access. For instance, a timer may be employed such that storage unit 120 (or the part that is unlocked) remains unlocked for a pre-defined period of time. Another protection mechanism is to limit the type of access to read-only access.

In one embodiment, a printed circuit board (PCB) of the mass storage device 100 of is extended to about half inch in length to accommodate the housing of wireless reader 160 and antenna 170. In another embodiment, a daughter board can be added to the PCB to house these components.

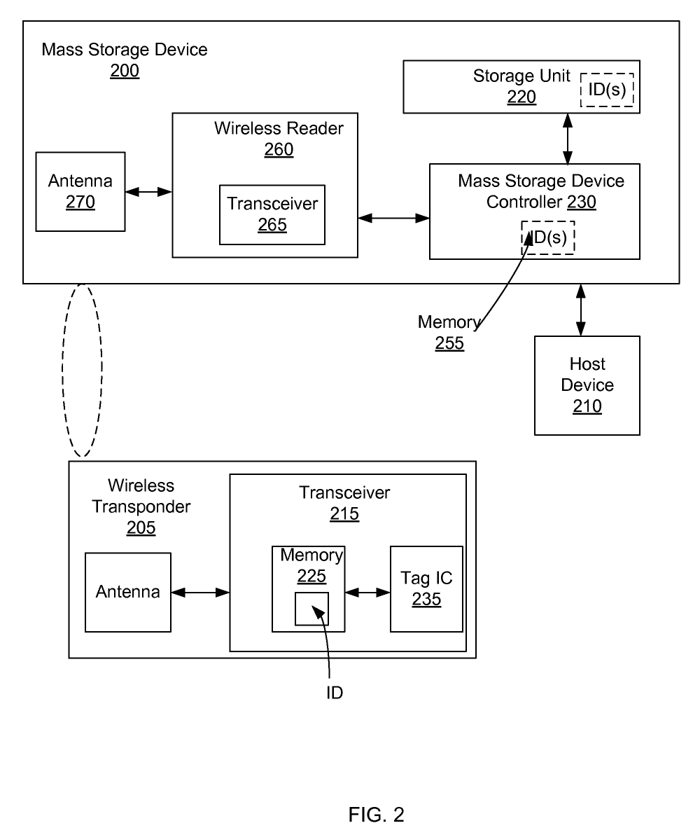

FIG. 2 illustrates an embodiment of a mass storage device 200 with locking mechanism according to an embodiment of the invention. Mass storage device 200 is similar to mass storage device 100, except wireless reader 260 of mass storage device 200 does not have a micro-controller unit. Instead, comparison of a received Identification Number with pre-stored data is performed at mass storage device controller 230. Accordingly, mass storage device controller 230 receives identification data from transceiver 265 and compares received identification data to pre-stored identification data and determines if there is a match. Pre-stored identification data can be stored on on-chip ROM 255 and/or in storage unit 220.

In some embodiments, transceiver 265 provides mass storage device controller 330 with information received from wireless transponder 205. In some embodiments, mass storage device controller 230 periodically polls transceiver 265 for information received from wireless transponder 205.

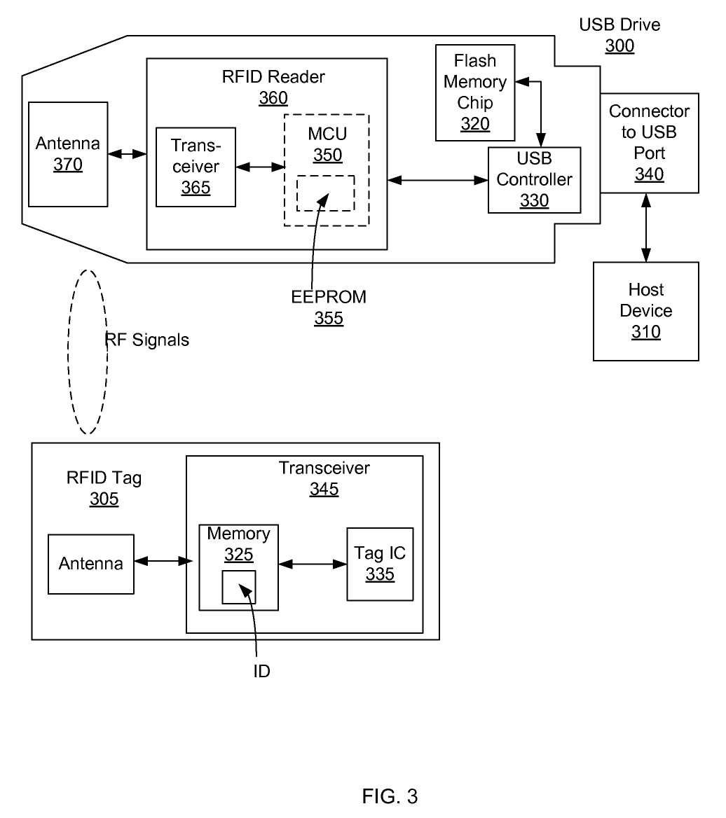

In some embodiments of the invention, as illustrated in FIG. 3, mass storage device is a USB drive 300. In some embodiments of the invention, mass storage device employs other interfaces such as SATA, ATA, 1394 or Serial Bus Interface. In some embodiments of the invention, as illustrated in FIG. 3, wireless reader is a Radio Frequency Identification (RFID) reader and wireless transponder device is a RFID tag. In some embodiments of the invention, wireless reader is a Near Field Communication (NFC) reader and wireless transponder device is an NFC tag.

As shown in FIG. 3, USB drive 300 has a USB controller 330, a flash memory chip 320 to store data, a connector 340 to interface with a host device 310, an integrated RFID reader 360, and an antenna 370. In one embodiment, RFID reader 360 emits radio frequency at a fixed frequency, such as at a low-frequency (around 125 KHz), a high-frequency (13.56 MHz), or at ultra-high-frequency or UHF (860-960 MHz). RFID reader 360 may have a range of from a few millimeters to several meters and more depending upon size of wireless transponder 305 (which in this case is an RFID tag), the operating frequency, and whether the RFID tag is a passive or active.

At the time when a user inserts a RFID locking USB drive device 300 into a USB port of host device 310, USB drive device 300 is locked and not accessible to host device 310. Accordingly, no USB drive device icon is shown on a display associated with host device 310. The user then passes RFID tag 305 by USB drive device 300 having RFID reader 360. RFID reader 360 transmits a magnetic field that provides power for RFID tag 305 to operate. RFID tag 305 transmits a stored Identification Number to RFID reader 360. transceiver 365 detects and sends tag Identification Number to MCU 350 (if one exists). MCU 350 processes tag data and checks to verify that tag data matches with identification data stored at USB drive device 300. If there is a match, MCU 350 will allow USB controller 330 to enumerate. If no MCU 350 exists, processing of tag data is performed by USB controller 330.

If there is a match, a USB drive icon will now appear on a display associated with host device 310 for the user to access data stored on Flash memory chip 320. If there is no match, the USB drive icon does not appear on the display associated with host device 310. USB Drive 300 may use one or more bits or a power switch to control access to flash memory chip 320 in the manner described with reference to FIG. 1. Also, USB controller 330 may determine if there is match between received tag Identification Number and pre-stored tag identification data in the manner described with reference to FIG. 2.

As discussed with reference to FIG. 1, more than one RFID tag 305 can be bundled with a USB drive 300. USB drive 300 remains unlocked as long as it is connected to host device's USB port with power on. Once the user removes USB drive 300 from the USB port, the mass storage device is locked. To unlock it again, the user has to go through the initialization process as described above.

In one embodiment, the PCB of the USB drive 300 is extended to about half inch in length to accommodate the housing of RFID reader 360. In another embodiment, a daughter board can be added to the PCB of USB drive 300 to house RFID reader 360.

RFID tag 305 and RFID reader 360 function as a short range transmitter and receiver respectively. In one embodiment, RFID tag 305 has an operating frequency of 125 kHz. In one embodiment, RFID tag 305 draws power from the integrated RFID reader's 360 magnetic field and is thus passive. In one embodiment, RFID tag 305 is a read-only tag and contains 128-bit of one-time-programmable identification, as described with reference to FIG. 7.

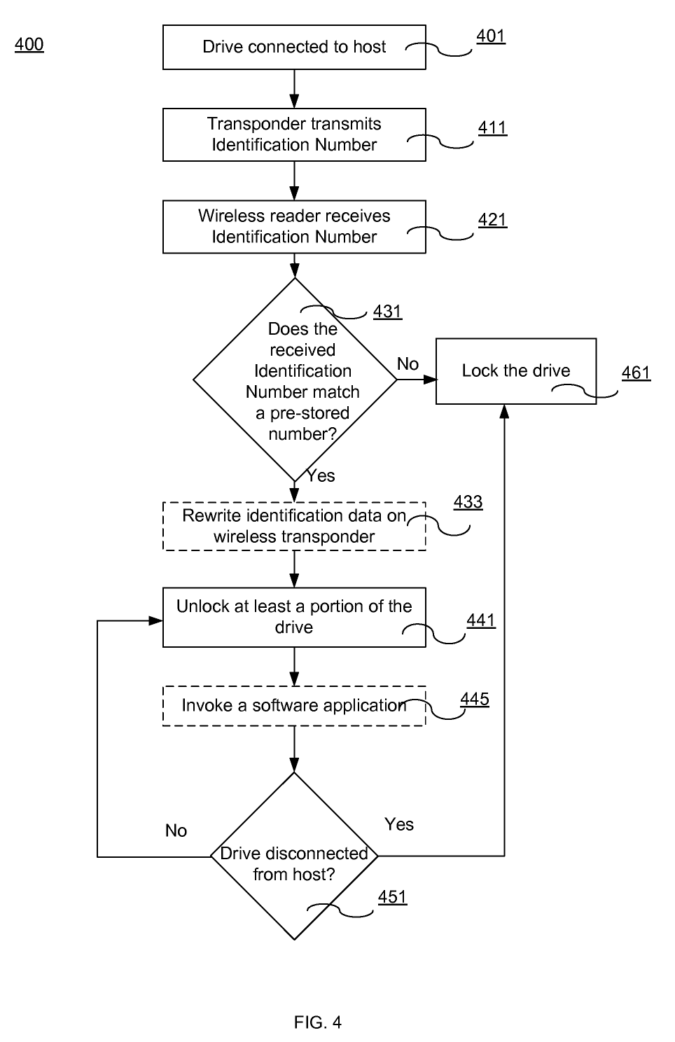

FIG. 4 illustrates a process 400 of unlocking a mass storage drive device according to some embodiments of the invention. At block 401, the mass storage drive device is connected or interfaced to a host device. However, all or part of the storage unit of the mass storage drive device is locked and cannot be accessed by the host device.

At block 411, to gain access to the locked storage unit, a user brings a wireless transponder within a proximal range of the mass storage drive device. The wireless transponder transmits an identification number associated with the wireless transponder, which is received by a wireless reader component of the mass storage drive device at block 421.

At block 431, one or more processing units of the mass storage drive device determine if the received identification number matches a pre-stored number. The processing may be performed by a micro-controller unit within the wireless reader or by a drive controller. If there is no match, then the mass storage drive device stays locked at block 461. Otherwise, if there is a match, at least a portion of the locked mass storage drive device is unlocked at block 441. Optionally, at block 433, the micro-controller unit (if one exists) or the drive controller rewrites the identification number stored on the wireless transponder, for enhanced security. Further, optionally, at block 445, the drive controller invokes a software application, for instance to backup data at the host device. The drive stays unlocked unless the drive is disconnected from the host at block 451.

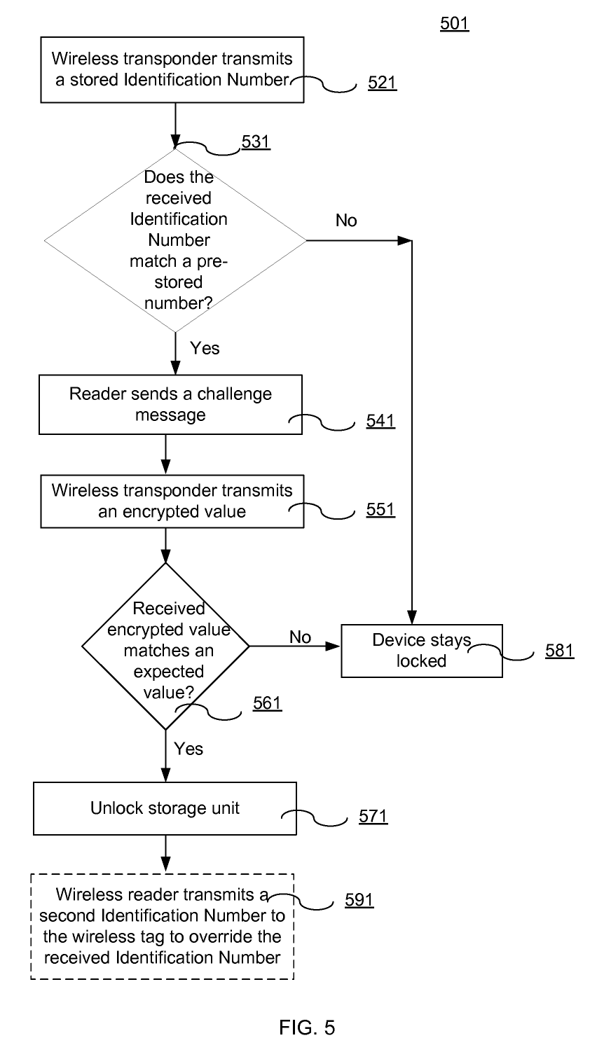

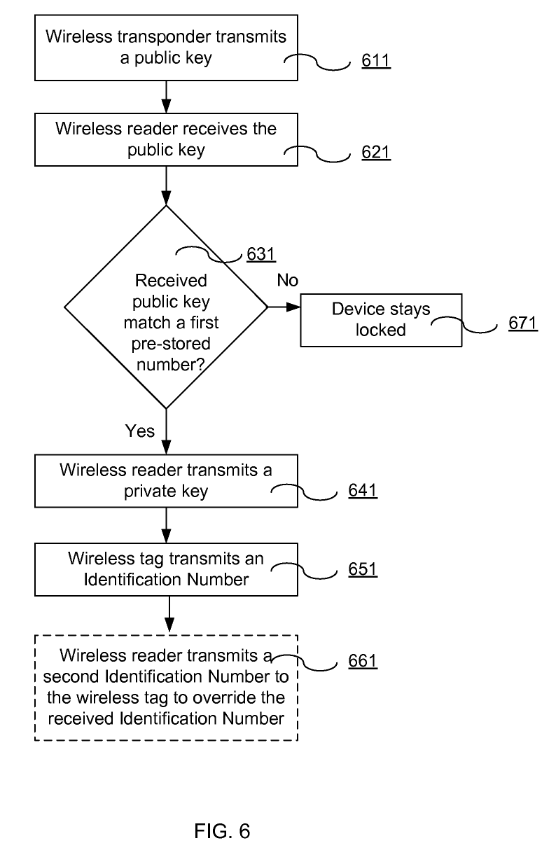

In some embodiments, for further security, a further challenge and response authentication process is used before unlocking, as described in reference to FIG. 5. In some embodiments, for enhanced security, public key cryptography is used before unlocking, as described in reference to FIG. 6. Other known security enhancement measures can also be used in addition to or in alternative of one or both of a challenge and response authentication process (for instance, like the one described in reference to FIG. 5) and public key cryptography (for instance, as described in reference to FIG. 6).

According to some embodiments, unlocking of the storage unit occurs after a successful challenge and response process 501 illustrated in FIG. 5. At block 521, the wireless transponder transmits and the wireless reader of the mass storage drive device receives an identification number. The wireless reader determines if the identification number from the wireless transponder matches a pre-stored number at block 531. If there is no match, the wireless reader terminates the connection between the wireless reader and the wireless transponder and the mass storage remains locked at block 581. If there is a match, the wireless reader sends a challenge message to the wireless transponder at block 541. In response to the challenge message, the wireless transponder transmits an encrypted value to the wireless reader at block 551. At block 561, the wireless reader decrypts the received encrypted value and determines if this value matches an expected value, and if so, proceeds to unlock one or more locked portions of the storage unit at block 571. Otherwise, the mass storage drive device stays locked at block 581. In one embodiment of the invention, at block 591, the wireless reader transmits a second Identification number to the wireless transponder to override the received Identification number.

According to some embodiments, for enhanced security, public key cryptography is used before unlocking of the storage unit occurs, as illustrated in process 601 of FIG. 6. At block 611, the wireless transponder transmits a public key, which is received by the wireless reader of the mass storage drive device at block 621. The wireless reader determines if the public key received from the wireless transponder matches a pre-stored public key at block 631. If there is a match, the wireless reader sends a private key to the wireless transponder at block 641. Otherwise, the mass storage drive device stays locked at block 671. Upon receiving the private key, the wireless transponder transmits its identification number to the wireless reader at block 651, which is then processed at the mass storage drive device. In one embodiment of the invention, at block 661, the wireless reader transmits a second Identification number to the wireless transponder to override the received Identification number.

FIG. 7 illustrates an embodiment of a transponder Identification Number decoding scheme 700. A transponder Identification Number uniquely identifies the transponder. In one embodiment, Identification Number is a 128-bit binary serial number, such that the first eight bits are reserved for manufacturer identification, the second eight bits are reserved for product identification, and the last 112 bits are reserved for manufacturing date, manufacturing time and sequential or random numbers.

In practice, and as recognized by those of ordinary skill in the art, items shown separately could be combined and some items could be separated. The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A mass storage device, comprising:
a mass storage unit to store data;
a wireless reader to receive first identification data from a wireless transponder; and
a first controller to enable access to at least a portion of the mass storage device if the first identification data matches a pre-stored data.

2. The device of claim 1, the wireless reader comprising a second controller to determine if the first identification data matches the pre-stored data.

3. The device of claim 1, the first controller to determine if the first identification data matches the pre-stored data.

4. The device of claim 2, further comprising:
a switch to connect the first controller device and the second controller device, the switch to power the first controller device if the second controller determines that the first identification data matches the pre-stored data.

5. The device of claim 1, the first controller device to lock an unlocked portion of the mass storage unit upon disconnection of the mass storage device from a host device.

6. The device of claim 2, the second controller device comprising:
a memory, the memory to store the pre-stored data.

7. The device of claim 6, wherein the memory is read-only.

8. The device of claim 6, wherein the memory is one of a group comprising EEPROM and non-volatile memory.

9. The device of claim 1, wherein the wireless transponder is one of a passive tag and a read-writable tag.

10. The device of claim 9, the wireless reader to:
write second identification data onto the wireless transponder.

11. The device of claim 1, wherein the mass storage device comprises an interface, the interface being one of a group comprising a USB interface, a SATA interface, an ATA interface, and an 1394 Serial Bus Interface.

12. The device of claim 1, wherein the wireless transponder is one of an RFID tag and a NFC tag, and wherein the wireless reader is respectively one of an RFID reader and NFC reader.

13. A method comprising:
at a mass storage device,
receiving first identification data from a first wireless transponder; and
unlocking at least a portion of a mass storage unit of the mass storage device upon determining that the first identification data matches a pre-stored data.

14. The method of claim 13, further comprising:
decrypting the first identification data at the mass storage device, wherein the first identification data is received in an encrypted form.

15. The method of claim 12, further comprising:
decrypting the first identification data at the mass storage device using a private key, wherein the first identification data is encrypted using a public key.

16. The method of claim 12, further comprising:
writing second identification data associated with the first wireless transponder onto a memory of the first wireless transponder.

17. The method of claim 16, further comprising:
transmitting the second identification data from the mass storage device to the first wireless transponder, wherein the second identification data is encrypted;
receiving the encrypted second identification data from the mass storage device at the first wireless transponder; and
decrypting the encrypted second identification at the first wireless transponder.

18. The method of claim 17, wherein the second identification data is encrypted using a public key, and wherein the second identification data is decrypted at the first wireless transponder using a pre-stored private key.

19. The method of claim 13, further comprising:
connecting the mass storage device to a host device, wherein the host device supplies power to the mass storage device; and
disconnecting the mass storage device from the host device, thereby locking the mass storage device.

20. The method of claim 13, further comprising:
providing access to at least a portion of data stored on the mass storage device.

21. The method of claim 13, further comprising:
invoking a software application upon unlocking the mass storage device.

22. The method of claim 13, further comprising:
writing second identification data associated with a second wireless transponder onto a memory of the first wireless transponder.

23. The method of claim 13, wherein the first wireless transponder is one of a group comprising a passive tag and a read-writable tag.

24. The method of claim 13, wherein the first wireless transponder is one of a group comprising an RFID tag and a NFC tag, and wherein the wireless reader is one of a group comprising an RFID reader and a NFC reader.
